(19) United States
(12) Patent Application Publication
(10) Pub. No.: US 2016/0046375 A1
(43) Pub. Date: Feb. 18, 2016

(54) FORWARD MOUNTED AUXILARY AIRFOILS WITH SPOILERS

(71) Applicant: Edward Parry McNair, Las Cruces, NM (US)

(72) Inventor: Edward Parry McNair, Las Cruces, NM (US)

(21) Appl. No.: 14/312,131

(22) Filed: Jun. 23, 2014

Related U.S. Application Data
(60) Provisional application No. 61/957,085, filed on Jun. 24, 2013.

(51) Int. Cl. B64C 39/12

(52) U.S. Cl. CPC B64C 39/12

(57) ABSTRACT

An axillary airfoil located as far forward as practicable on the fuselage of an airliner. During high speed cruise, the airfoil can be adjusted to provide supplemental lift to move the center of pressure forward, thereby reducing the amount of downforce needed to be produced by the vertical stabilizer. This would result in saving fuel. Spoilers mounted on the airfoils would be programmed to automatically deploy to return the center of pressure rearward whenever flight conditions require greater longitudinal stability.

### CROSS-REFERENCE TO RELATED APPLICATIONS

Provisional Patent Application No. 61/957,085 filed on Jun. 24, 2013

### BACKGROUND-FIELD OF THE INVENTION

Even though, modern airliners have very sophisticated, computer controlled autopilots, these aircraft must have sufficient aerodynamic characteristics of pitch, roll, and yaw stability that they can be hand flown by a pilot throughout a wide range of flight conditions and maneuvers in the event of computer or autopilot failure.

An important consideration when designing s longitudinally stable airplane is the balance between the center of gravity and the center of pressure of the wing. The center of pressure or CP is a point along the wing chord line where lift is considered to be concentrated. To achieve longitudinal stability, a conventional airplane is designed with its center of gravity or CG far enough forward of its CP so it is nose heavy in all phases of flight.

Hypothetically, the CP can be considered a fulcrum and the distance between the CG and the CP a lever arm. A horizontal stabilizer, located at the tail of the aircraft, offsets this nose heavy tendency of an airplane by being designed with a negative angle of attack with respect to the relative wind to produce a downward force called the tail-down force. Its distance from the CP can also be considered a lever arm and is the balancing force in most flight conditions.

The stabilizer will cause the aircraft to self correct. If the nose is pitched up, the negative angle of attack of the tail is reduced, so it generates less tail-down force, allowing the nose to drop. On the other hand, if the nose is pitched down, the tail creates more tail-down force, raising the nose.

If the CP and the CG are too close together, the aircraft is not sufficiently nose heavy to be stable in pitch for all conditions of flight. With insufficient aerodynamic longitudinal self correcting force, when turbulence or a control input changes the aircraft's pitch, the nose could continue to pitch up or down, unless there is an immediate control correction.

The further aft the CP is relative to the CG, the greater the aircraft's stability; however, the greater the tail-down force required of the stabilizer. If the CG and CP are too far apart, it will adversely affect the aircraft's maneuverability and reach the limits of the horizontal stabilizer's and elevator's ability to control the aircraft's pitch. Thus the CG must be located within a limited range forward of the CP. This is referred to as the CG limits.

An example of one of the possible conditions that must be taken into consideration when calculating an aircraft's CG limits is that occasionally, an aircraft might have to slow down to its maneuvering speed, a speed slow enough that it will stall before extreme turbulence can cause structural failure. This slow speed results in a very high angle of attack. In the unlikely event of such a stall, it is important that the airplane is nose heavy so that the nose will drop, which will increase airspeed and help the airplane to recover from the stall.

Although the tail-down force created by the horizontal stabilizer is necessary for longitudinal stability and balance, it is aerodynamically inefficient. The wings must support the negative lift created by the tail-down force, which increases induced drag. Both the increased negative angle of attack of the stabilizer and positive angle of attack of the wing increase parasitic drag. These drags, in turn, increase the power required of the engines, and increase fuel consumption.

The CG limits for an aircraft are established during design, initial testing, and airworthiness certification of each airplane to provide sufficient longitudinal stability for safe operation. These limits are based on worse case scenarios such as extreme turbulence and low airspeeds.

The CG limits represent a range of locations where the CG can occur. It will vary with the amount and type of the cargo and must be calculated before every flight. Once an airliner is loaded, the CG will remain fixed except for minor variations, such as people walking up and down the aisles.

During flight, the exact location of the CP of an aircraft varies with airspeed. It is furthest forward at the stall speed and, as airspeed increases, aerodynamic forces cause the CP to shift to the rear, increasing the tail-down force required.

Most of a commercial airliner's operating time and fuel consumption occurs at medium to high speed cruise. If the distance between the CP and the CG could be adjusted in flight so that the distance between them is just enough that the aircraft remains stable for the flight environment at the time it would result in substantial reduction in fuel consumption, For example, during routine cruise through smooth air with all control systems, such as a computer controlled autopilot, functioning correctly, the CP could be adjusted to be adjacent to and directly to the rear of the CG and the tail-down force would then be minimal.

This would be feasible for an airliner if it had a controllable means of decreasing the distance between the CG and CP during flight when it is safe to do so; and a means of increasing this distance as rapidly as needed to not compromise safety when greater stability is warranted.

Occasionally, due to other design parameters, aircraft can be too nose heavy. One way to alleviate this problem is to install additional small horizontal airfoils well forward of the main wing. There are aircraft in use today that have auxiliary airfoils exerting lift forward of the CG to obtain a desired location for the CP, either as a part of the aircraft's original design or as a modification.

An example of forward mounted auxiliary airfoils included in the original design of the aircraft is the PIAGGIO AERO INDUSTRIES S.p.A. “P 180 AVANTI” business turboprop. This aircraft's main wing is located aft of the passenger cabin so it doesn't intrude on space for passengers. With the wing so far aft, the balancing loads from a high negative angle of attack of the horizontal tail would be huge and that would add excess drag. So a small forward wing adds lift to relieve loads on the horizontal tail, which then can be smaller in size. The AVANTI is a three surface airplane with the conventional horizontal T-tail providing all the pitch controls while the forward surface adds lift and reduces the load on the horizontal tail. The only thing that is adjustable on the AVANTI'S forward wing is a small flap that extends in concert with the main wing flap to balance the pitch changes caused by the extension of the main flap at low airspeeds during takeoffs and landings.

A second example of a forward mounted airfoil currently in use as a modification to a previously manufactured aircraft is one for a CESSNA 182, a four passenger, single engine light aircraft. This particular aircraft, with a large, six cylinder engine, is relatively nose heavy. This is due to the fact that the 182 has a high wing that has to be mounted in a position far enough back that the pilot can see where he or she is going when the plane is banked in a turn. Without modifying the main wing or the horizontal tail, PETERSON'S PERFORMANCE PLUS INC, of El Dorado, Kans. installs a small rigid airfoil near the nose of the 182. The rigid airfoil moves the CP forward, but still allows a useful load between the fore and aft CG limits.

### SUMMARY OF THE INVENTION

The objects of the invention are:

(a) to provide a means to controllably shift the CP forward as the angle of attack of the main wing decreases at high airspeeds, and shift the CP rearward as the angle of attack increases at lower airspeeds;

(b) to provide a means to return the CP rearward to its original position in a sufficiently rapid and dependable manner whenever necessary thereby increasing the amount of tail-down force immediately in the event of an unexpected incident such as encountering clear air turbulence.

The invention is comprised of mounting an airfoil on the fuselage of an aircraft as far forward of the aircraft's main wing and CG as practicable. Each airfoil would be capable of exerting a lifting force that would supplement the lifting force of the main wing. Each airfoil would have at least one spoiler mounted on its upper surface to rapidly reduce that lift and return the CP to its original rearward position should an unexpected destabilizing event occur.

The embodiments that follow will also show means to adjust the airfoils to reduce their parasitic and induced drag during portions of the aircraft's flight when a forward shift of the CP is not desired. During takeoff and climb, if the airfoils are in a low lift position, spoilers on the airfoils are retracted. As the aircraft approaches its cruise altitude and speed, the airfoils can be adjusted in flight by the aircraft's autopilot control system to create enough additional lift to temporarily move the aircraft's CP forward, closer to the aircraft's CG. Whenever necessary for safety, the spoilers could be quickly extended. During routine operation, for example the decent and landing phase, the airfoils would gradually be returned to their neutral lift position.

### BRIEF DESCRIPTION OF THE DRAWINGS

FIG. 1A is a schematic plan view of a commercial transport aircraft with airfoils forward of the main wing.

FIG. 1B is a partial schematic plan view of the aircraft showing a forward airfoil with spoilers and a flap mounted thereon.

FIG. 1C shows a partially retracted forward airfoil and spoiler.

FIG. 2 diagrams an angle of attack.

FIG. 3A-3C are schematic, cross sectional views of a forward airfoil having a flap and a spoiler as shown in FIG. 1B.

FIG. 3D is a view of an airfoil having a spoiler as shown in FIG. 1C.

FIG. 4A,B are partial views showing details of the airfoil depicted in FIG. 1B and FIGS. 3A-3C.

FIGS. 5A,B show details of an articulating airfoil.

FIGS. 6A,B are detailed views of an airfoil with a flap.

FIGS. 7A-7C show an airfoil fully retracted, partially extended, and fully extended, respectively.

FIG. 8 is an isometric view showing two positions of the airfoil depicted in FIGS. 5 A,B.

### DETAILED DESCRIPTION OF THE INVENTION

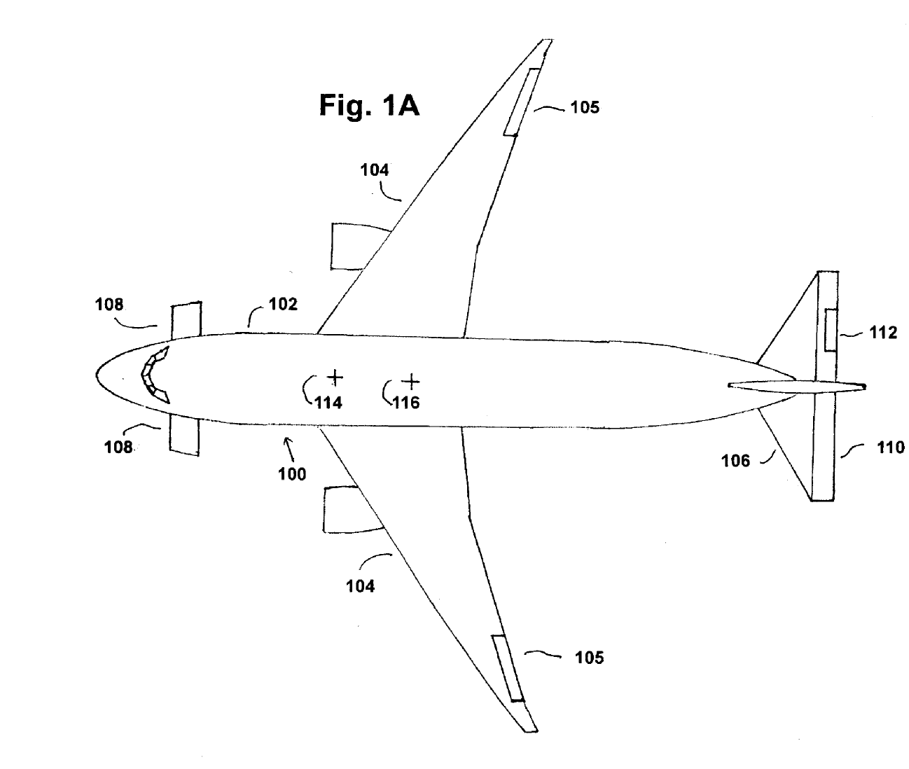

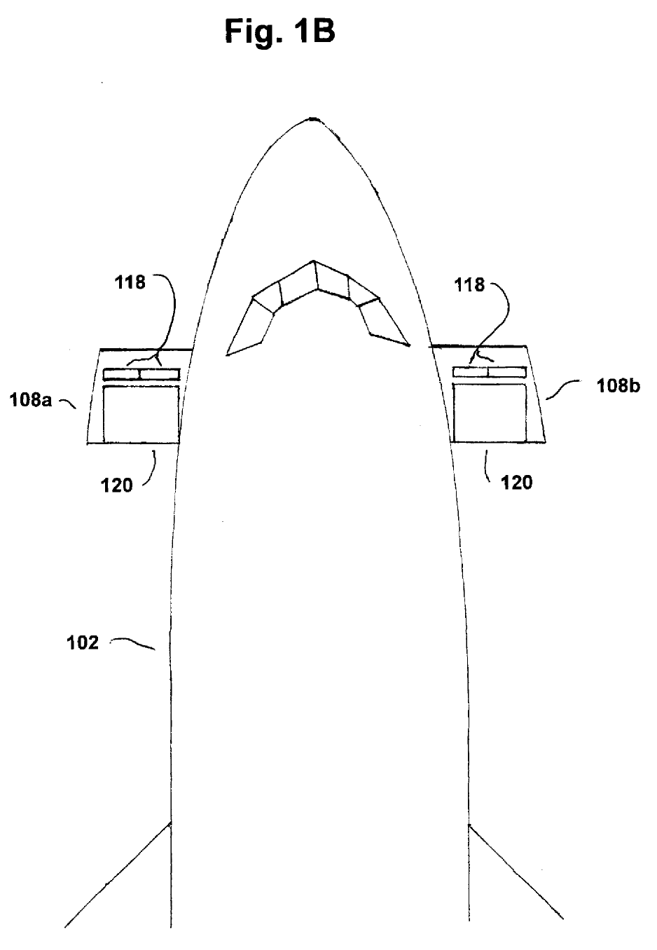

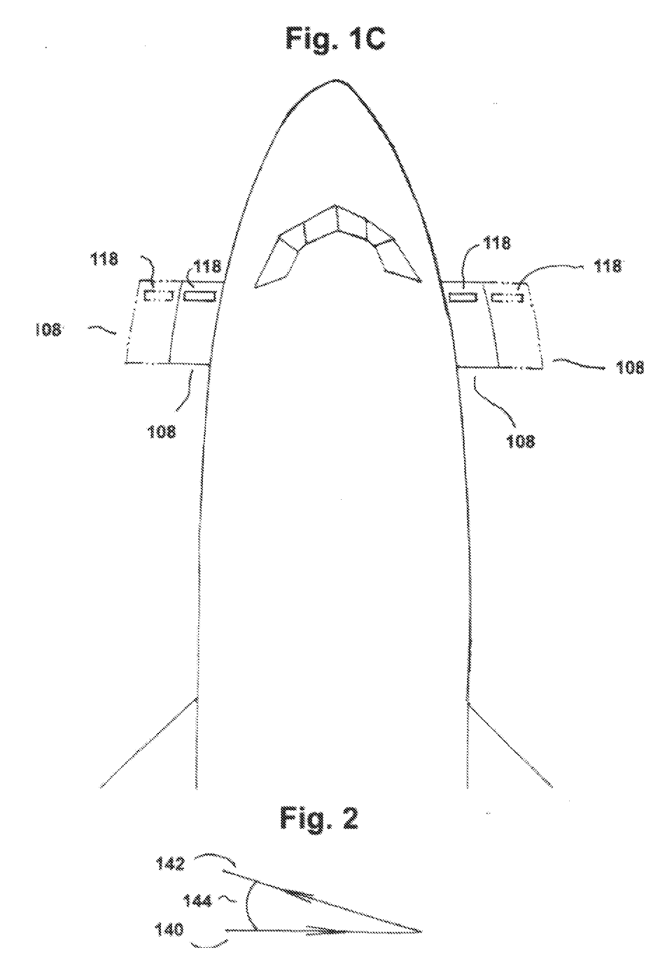

A commercial transport aircraft 100 of conventional design shown in FIG. 1A is comprised of a fuselage 102 and a pair of main wings 104 located amidships. Ailerons 105 are mounted on the trailing edges of wings 104 respectively. A horizontal stabilizer 106 is located near the tail of fuselage 102. Attached to the rear of stabilizer 106 is an elevator 110. A trim tab 112 is mounted on elevator 110. An airfoil assembly, comprised of a pair of airfoils 108 and mechanisms for configuring them, have been retrofitted near the nose of fuselage 102. Points representing a CG 114 and a CP 116 are located amidship.

FIG. 1B shows spoilers 118 mounted on the top surface of airfoils 108 Articulating flaps 120 are an integral part of airfoils 108.

FIG. 1C shows retractable airfoils 108 with spoilers 118 mounted thereon, fully extended and partially retracted into fuselage 102.

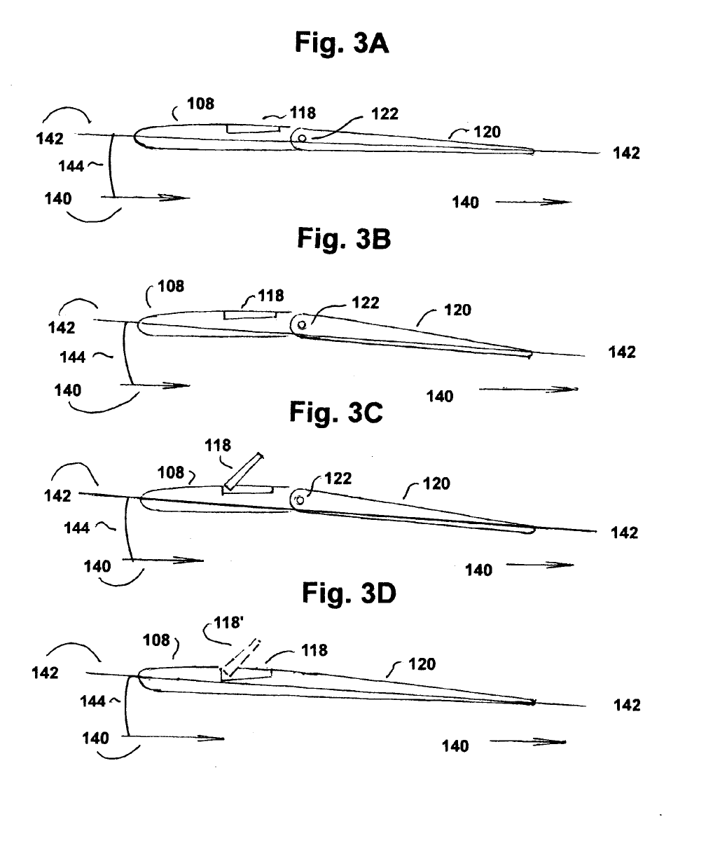

FIG. 2 is a vector diagram showing the angle of attack 140 between the longitudinal cord line 142 of an airfoil and the direction of the relative wind 144. Chord line 142 is an imaginary straight line drawn from the leading edge to the trailing edge of an airfoil. Relative wind is the airflow that is parallel to and opposite the direction of the flight path of aircraft 100. The combined surface areas of airfoils 108 are substantially smaller than the surface areas of either stabilizer 106 or main wings 104; therefore, stabilizer 106 and wings 104 determine the direction of the relative wind 144 for aircraft 100. Increasing angle of attack 140 increases lift. A change in chord line 142 relative to aircraft 100 will create a corresponding change in the angle of attack of airfoil 108.

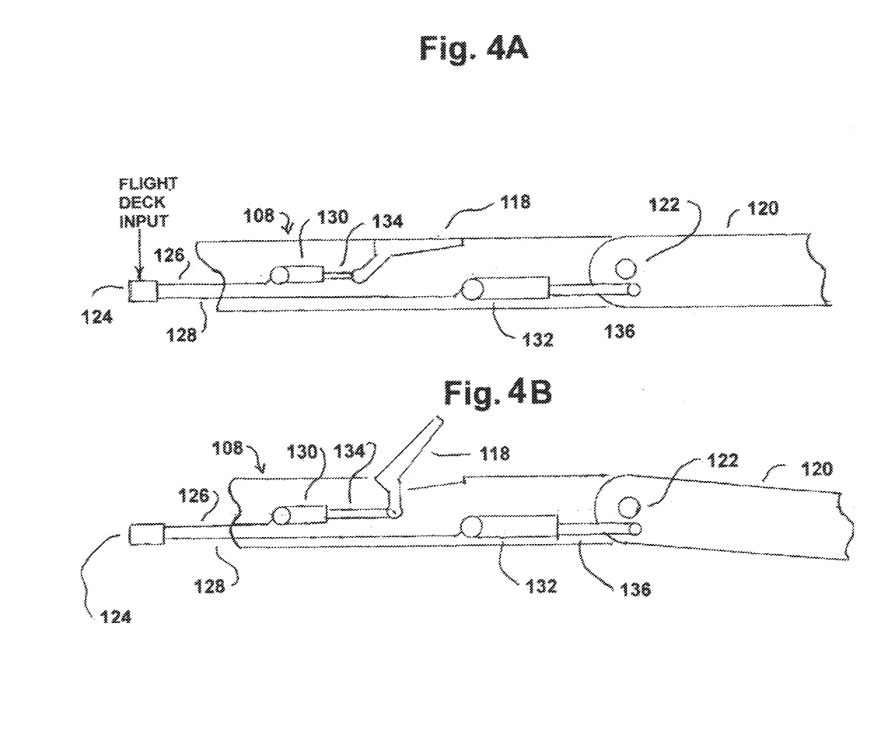

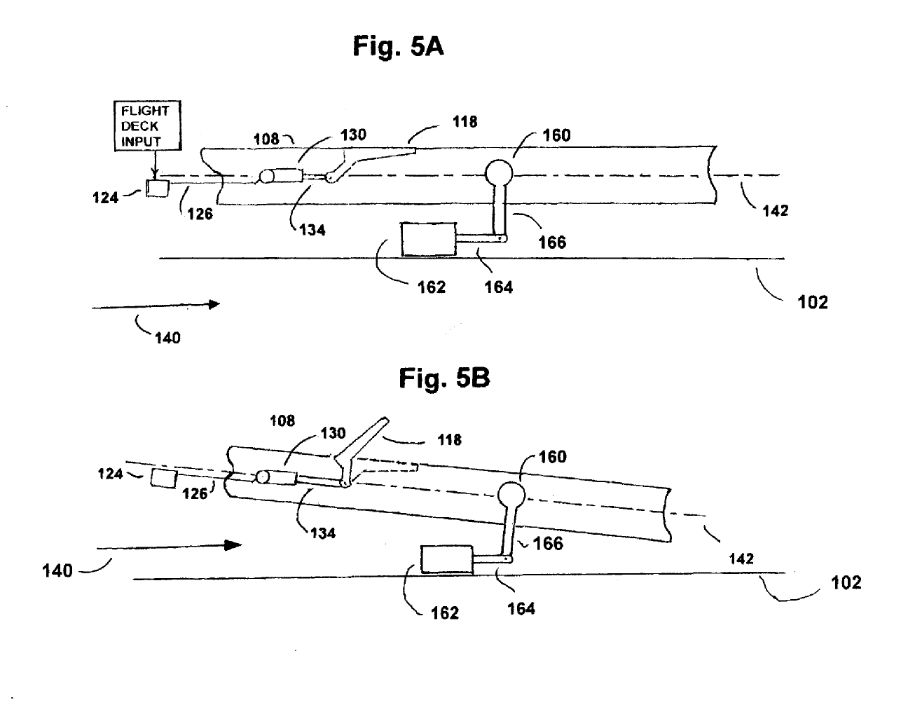

FIGS. 3A-3C are cross sectional views showing spoiler 108 with flap 120 attached by means of a flap hinge 122. Spoiler 118 is installed on airfoil 108. Relative wind 140, chord line 142, and angle of attack 144 for airfoil 108 are also shown.

In FIG. 3A, spoiler 118 and flap 120 are retracted. In FIGS. 3B, spoiler 118 is retracted into airfoil 108, and flap 120 is extended. In FIG. 3C, spoiler 118 and flap 120 are extended.

FIG. 3D shows airfoil 108 with spoiler 118 retracted and extended. Angle of attack 144 for airfoil 108 is fixed.

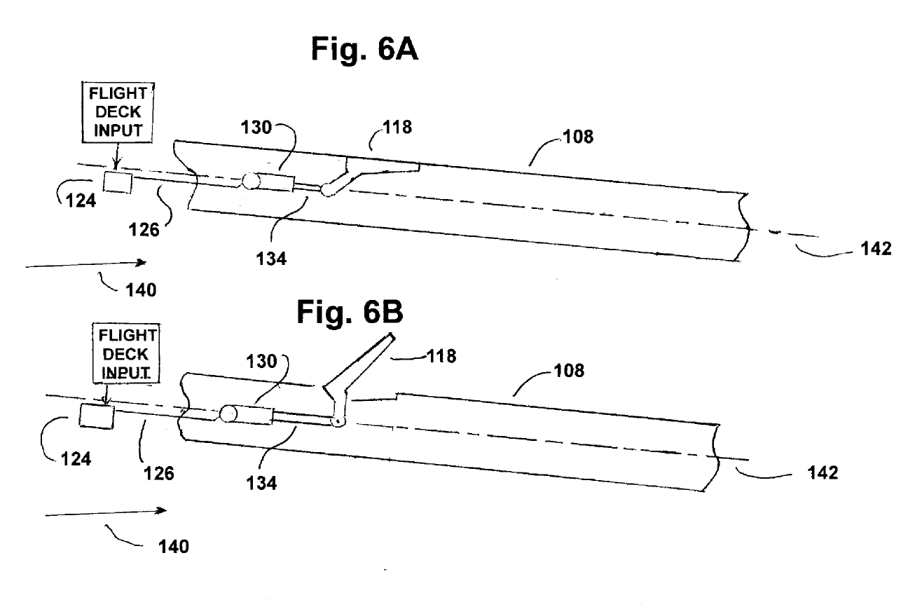

Taken together, FIG. 3A and FIG. 4A represent airfoil 108 with spoiler 118 and flap 120 retracted. In this configuration, chord line 142 and relative wind 140 are nearly parallel. Angle of attack 144 is nearly zero.

FIGS. 4A,B are enlarged partial cross sectional views showing details of operation of airfoil 108 depicted in FIGS. 3A-3C. Referring to FIGS. 4A,B, an electronic input signal from the flight deck can be transmitted to a controller 124. Controller 124 can process command signals from the flight deck, including commands from a pilot, computerized auto pilot, or sensors such as accelerometers and also contain a backup computer dedicated to processing “fail safe” signals. Controller 124 is connected by means of a spoiler signal link 126 to a spoiler actuator 130. Spoiler actuator 130 is comprised of a direct current push type solenoid. Since it is a direct current solenoid the polarity of the electric signal positively controls the solenoid's motion in either direction.

Spoiler actuator 130 is coupled to spoiler 118 by means of a spoiler push pull rod 134 which can extend or retract spoiler 118 in a variety of intermediate positions

A flap 120 is pivotally mounted on airfoil 108 by means of a hinge 122. Controller 124 is coupled to flap actuator 132. Flap actuator 132 can be actuated and controlled by in a manner similar to that described above with reference to spoiler actuator 130. Flap actuator 132 is an electric servo motor typically used for the extension and retraction of flaps and is coupled to flap 120 by a flap push pull rod 136.

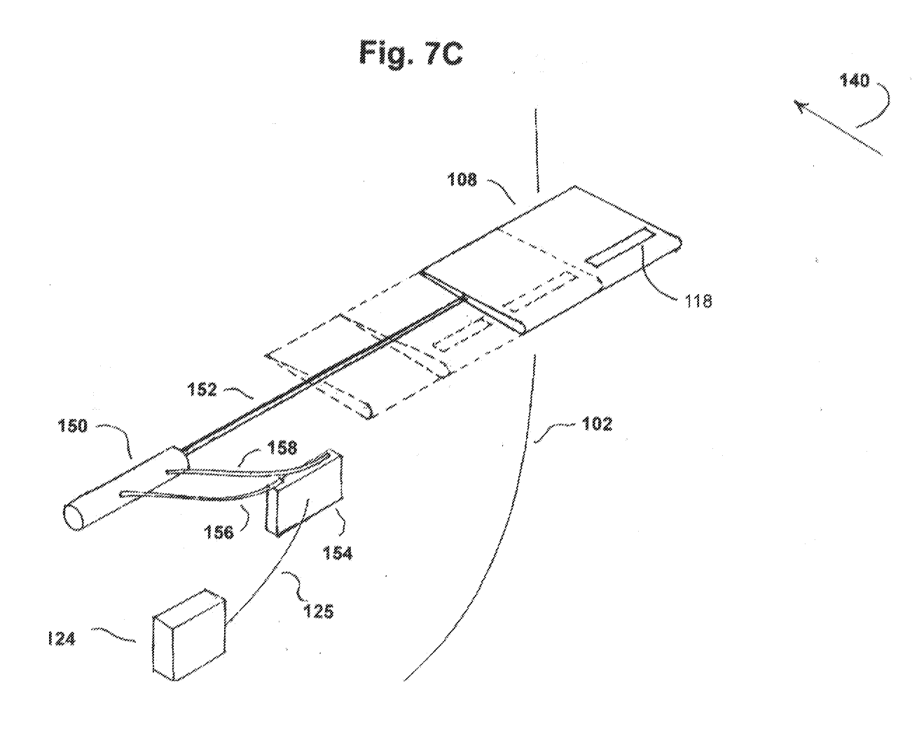

FIG. 1C, and FIGS. 7A,B,C, show aircraft 100 with retractible airfoils 108 fully retracted, partially extended, and fully extended horizontally out of fuselage 102. Angle of attack 144 is fixed. The amount of lift generated by airfoil 108 is determined by the surface area of airfoil 108 extended into relative wind 140.

Referring to FIGS. 7A,B,C. Airfoil 108 with spoiler 118 mounted thereon has a fixed angle of attack as shown in FIG. 3D. Airfoil 108 can extend and retract through an opening in fuselage 102. By means of a control transmission link 125, controller 124 can signal a hydraulic pump 154 to pump hydraulic fluid through either a hydraulic extension line 156 or a hydraulic retraction line 158 to an airfoil extension actuator 150 which is comprised of a hydraulic cylinder, can cause an actuator push pull spar 152 to extend or retract. Spar 152, rigidly attached to airfoil 108, can extend and retract airfoil 108 through the opening in fuselage 102.

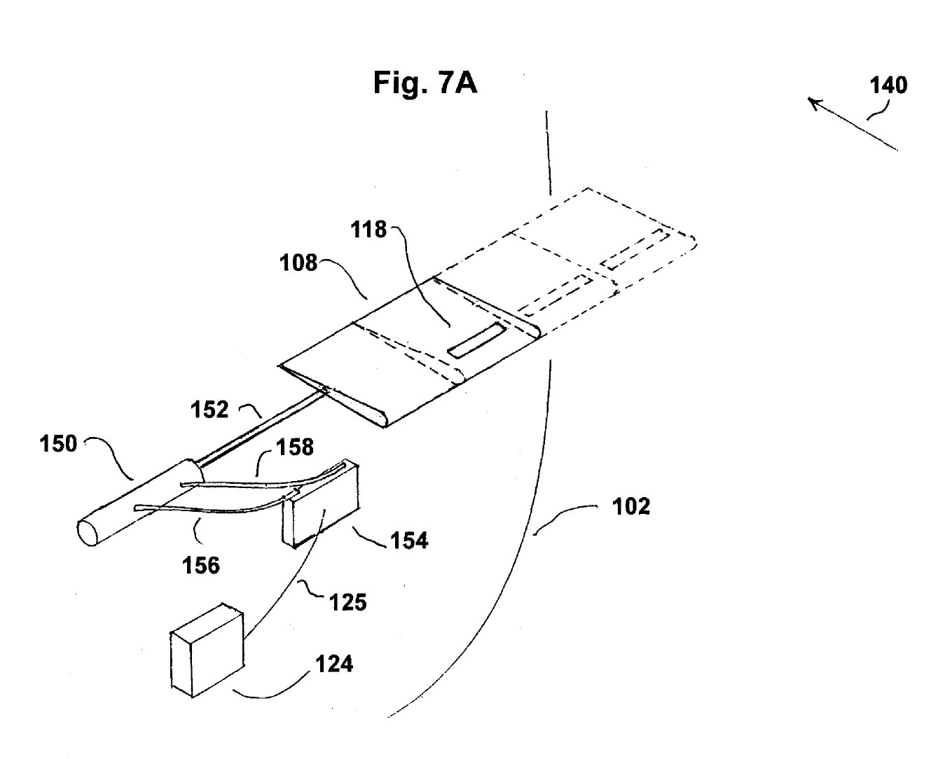

FIGS. 5A,B show airfoil 108 at two different positions with respect to relative wind 140. Controller 124 can send a command signal by means of a spoiler signal link 126 to a spoiler actuator 130. Spoiler actuator 130 is coupled to spoiler 118 by means of a spoiler push pull rod 134 which can extend or retract spoiler 118 in a variety of intermediate positions.

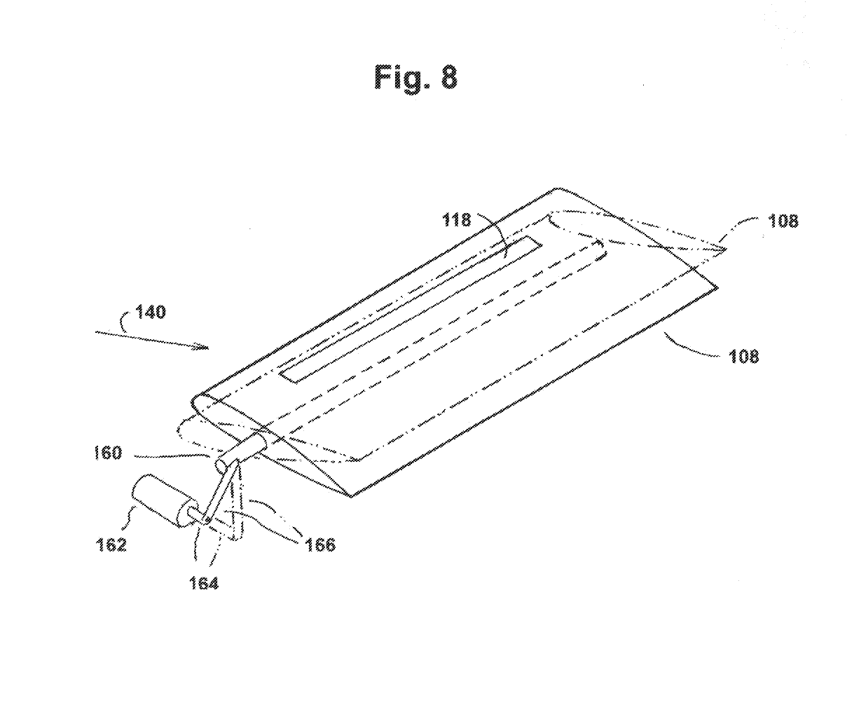

Referring to FIGS. 5A,B and FIG. 8, airfoil 108 is attached to fuselage 102 by means of main spar 160, that is rotatable on the lateral axis of aircraft 100 A spar arm 166 is rigidly connected to spar 160 and has an articulating connection to a piston rod 164. Piston rod 164 is operated by a n airfoil tilting actuator 162 comprised of a hydraulic cylinder.

### Operation of the Invention

In the first embodiment, as shown in FIGS. 1A and 1B, a conventional aircraft 100 has been retrofitted with airfoil 108 mounted on fuselage 102 ahead of main wings 104 and ahead of both the CG 114 and CP 116. As shown in FIGS. 3A and 4A, during take off and climb, spoiler 118 and flap 120 are both in the retracted position. Retrofitting aircraft 100 with the airfoil assembly comprised of airfoil 108 and control wiring together with materials necessary to reinforce fuselage 102 have added weight in that area, so airfoil 108 has been rigged so that at cruise speeds in this configuration, airfoil 108 will generate sufficient lifting force on fuselage 102 at the location where airfoil 108 is mounted to neutralize this added weight thus leaving the distance between CG 114 and CP 116 virtually unchanged.

As shown in FIGS. 3A, 3B, 4A and 4B as aircraft 100 reaches its cruise altitude and speed, and is being flown by autopilot, if the pilot determines that the prognosis for the flight conditions are suitable, i.e. little or no anticipated turbulence, the pilot can input a command to the autopilot to extend flap 120. When signaled from the autopilot, controller 124 sends a command through flap signal link 128 to flap actuator 132. Actuator 132 retracts push pull rod 136 to extend flap 120 to a predetermined position causing chord line 142 to increase angle of attack 144 of airfoil 108 as shown in FIG. 3B. The increase of angle of attack 144 increases the coefficient of lift which increases the lifting force of airfoil 108. When this lifting force increases, CP 116 is moved forward on fuselage 102. At the same time as CP 116 is moved forward the autopilot controls elevator 110 and adjusts trim tab 112 to maintain the flight attitude of aircraft 100.

Should flight conditions suddenly change, e.g. unexpected clear air turbulence, partial malfunction of the autopilot, pilot overriding the autopilot, a signal from an accelerometer, an automatic command from the autopilot, or a loss of signal from the flight deck; controller 124 would send a signal through spoiler signal link 128 to spoiler actuator 130 causing spoiler 118 to extend in a rapid manner as shown in FIGS. 3C and 4B. This will result in the immediate dumping of the additional lifting force created by airfoil 108. Later, if flight conditions permit, controller 124 can be directed to signal spoiler actuator 130 with a reverse polarity current to retract spoiler 118.

Spoiler 118 and flap 120 could be any of numerous standard designs known to those versed in the art. They would be empirically adapted to this application so that the amount of lift dumped when spoiler 118 is fully extended is in close approximation to the amount of lift previously created by the increase of angle of attack 142 caused by the extension of flap 120 and lifting force will revert to the amount that is generated when spoiler 118 and flap 120 are fully retracted. This would result in the immediate rearward shift of CP 116. During this transition period, unless previously disengaged by the pilot, the autopilot will simultaneously exert pressure on elevator 110 as it adjusts trim tab 112 to compensate for a rearward shift of CP 116.

If the pilot estimates that the cause of the deteriorated flight conditions is probably going to be brief, the pilot can continue to fly with spoiler 118 and flap 120 extended. Then, when the need for greater stability, such as a brief period of turbulence, is passed, the pilot can turn off the “Fasten Your Seatbelt” sign and retract spoiler 118 which would return CP 116 to its forward position. On the other hand, if the pilot estimates that the cause might continue for a longer period of time, he or she can send a signal to controller 124 in order to reduce both the induced and parasitic drag of airfoil 108,. Controller 124 would issue a simultaneous command to spoiler actuator 130 and flap actuator 132 causing spoiler 118 and flap 120 to retract in a synchronized manner so that the lifting force and CP 116 remain unchanged.

### Additional Embodiments

In the second embodiment, airfoil 108 has a fixed angle of attack as shown in FIG. 3D. As shown in FIG. 7A, 7B, 7C, airfoil 108 can be fully retracted and controllably deployed horizontally from fuselage 102 to numerous positions.

While aircraft 100 is at the gate, airfoil 108 would be fully retracted as shown in fig FIG. 7A in order to not interfere with access to fuselage 102 by ground service trucks or the airway ramp extended from the terminal.

As aircraft 100 taxies for takeoff, the pilot extends airfoil 108 for takeoff and climb by sending a command to controller 124. Controller 124 sends a signal through transmission link 125 to hydraulic pump 154 to pump hydraulic fluid through extension line 156 to actuator 150. At the same time, retraction line 158 allows hydraulic fluid to return to pump 154. actuator 150 extends push pull rod 152 to partially extend airfoil 108 to the position shown in FIG. 7B which represents the point where lifting force 148 would approximately equal the additional weight of the retrofitted airfoil assembly.

As the aircraft becomes airborne, the exact intermediate position of airfoil 108 beyond the position shown in FIG. 7B can be adjusted by computer to compensate for the weight of the airfoil assembly at various airspeeds. Spoiler 118 is mounted on the outboard portion of airfoil 108 so that it will function at any point of extension of airfoil 108 beyond the position shown in FIG. 7B in the same manner as described in the first embodiment.

As aircraft 100 reaches cruise altitude and speed, the pilot can cause airfoil 108 to extend to the position shown in FIG. 7C. Spoiler 118 can be deployed at any time during this transition if necessary. Before or during decent for landing, the pilot causes airfoil 108 to be retracted to the position shown in FIG. 7B when hydraulic pump 154 pumps fluid through retraction line 158 and fluid returns to pump 154 by means of extension line 156.

After landing, while taxiing to the gate, the pilot can fully retract airfoil 108 as shown in FIG. 7A.

In a third embodiment, airfoil 108 can be articulated from a position where chord line 142 is as shown in FIG. 3A to the position as shown in FIG. 3D.

FIGS. 5A, B, and FIG. 8 show airfoil 108 mounted on fuselage 102 by means of a airfoil main spar 160. Spar 160 and airfoil 108 together rotate along a lateral axis of aircraft 100. Airfoil tilting actuator 162 is mounted on fuselage 102. A floating piston (not shown) in tilting actuator 162, is linked by a piston rod 164 to a spar arm 166 that is rigidly attached to spar 160.

During takeoff, climb and decent airfoil 108 is in the low lift configuration shown in FIGS. 3A, 5A and 8, and the angle of attack 144 between between the relative wind 140 and chord line 142 is minimal. As shown in FIG. 5B and 8 during high speed cruise in smooth air, the pilot can cause tilting actuator 162 to retract piston rod 164 causing spar arm 166 and spar 160 to rotate airfoil 108 to the high lift position shown in FIG. 3D. 5B and 8. Should unexpected turbulence make it necessary, spoiler 118 can be quickly extended at any time to eliminate the additional lift. Extending piston rod 164 will return airfoil 108 to the position shown in FIG. 5A for decent and landing.

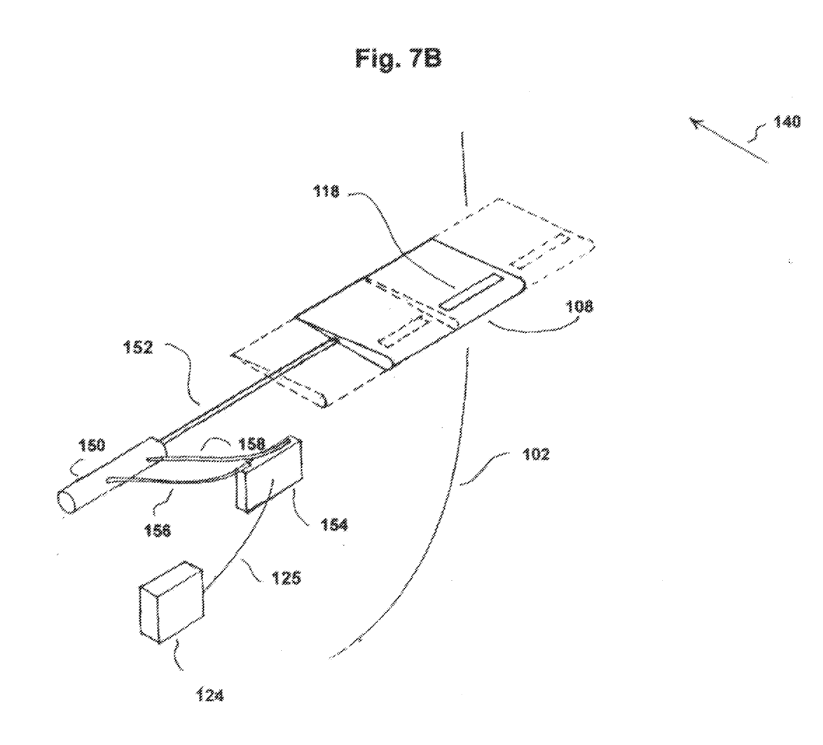

In a fifth embodiment, airfoil 108 is in a fixed high lift position as shown in FIGS. 1C, 3D and 6A,B. Spoiler 118 would be normally extended during takeoff, climb, decent, and landing as shown in FIG. 6B wherein airfoil 108 is in the low lift mode.. When conditions permit, a command from the flight deck is sent to controller 124, Controller 124 sends a command to retract spoiler 118 by means of spoiler signal link 126 to spoiler actuator 130 causing spoiler 118 to retract as shown in FIGS. 3D and 6A. When spoiler 118 is retracted, airfoil 108 is in the high lift mode. To return to the low lift mode, controller 124 sends a command to extend spoiler 118 by means of spoiler signal link 126 to spoiler actuator 130 causing spoiler 118 to extend as shown in FIG. 6B.

While the embodiments discussed above assume that the airfoils 108 mounted on either side of fuselage 102 are identical and at similar locations, the reader can see that they could be offset, of unequal size, or a single airfoil on one side only. For example, a single airfoil 108 could be mounted on the starboard side of aircraft 100 so as not to interfere with the main passenger door. When airfoil 108 exerts lift on the starboard side of aircraft 100, the pilot or autopilot would compensate for this asymmetrical lift by adjusting ailerons 105.

Some airliners are equipped with a stabilator, rather than a horizontal stabilizer and elevator as shown in the embodiments. These aircraft might particularly benefit from these improvements since the stabilator would self align when less tail-down force is needed to minimize parasitic drag.

Although the embodiments illustrate a specific condition, namely high speed cruise, it will be obvious to the reader that there may be other situations where some additional lift on an optional basis would be advantageous, for example during an aircraft's takeoff and climb.

An adjustable CP would also allow a greater flexibility in the loading of cargo. Currently, for greater fuel efficiency, both airliners and air freighters try to load cargo so that the CG is as close to its aft limit as practicable.

The several embodiments illustrate different ways to routinely increase and decrease the lifting force of forward airfoils to adjust the CP during flight; however, how far forward the CP can be safely moved for any aircraft depends on how rapidly the CP can be returned to its original rearward position at anytime. The use and deployment of spoilers provides a superior means of doing so. Spoilers have low mass so they can be deployed quickly to immediately convert laminar flow to turbulent flow, thereby “spoiling” the lift of the airfoils

A spoiler system can be designed to be deployed automatically in the event of a control computer malfunction, unexpected turbulence, or any sudden maneuver by the pilot. As such, it represents a “Fail Safe” means of assuring an aerodynamically stable aircraft at all necessary times

Some military aircraft are so unstable that they can only be flown by its human pilot with (redundant) computer assistance. While feasible, it is doubtful that the flying public would accept that condition in commercial airliners in the foreseeable future.

Tail-down force represents dead weight that has to be compensated for by fuel burn. Having an adjustable Center of Pressure with a reliable and rapid means to restore it to its original rearward location, takes advantage of computer stabilized flight to minimize tail-down force when practicable, without compromising the safety of an aerodynamically stable aircraft capable of being flown by a pilot whenever necessary.

1. An aircraft comprised of:
a fuselage;
a main airfoil means of creating a lifting force;
a second airfoil means of creating a downforce positioned aft of the main airfoil, said second airfoil togrther with said main airfoil provide a means whereby the longitudinal stability and balance of said aircraft are controlled;
a third airfoil means of creating a variable lifting force positioned forward of the main airfoil;
a system for controlling the variable lifting force of the third airfoil comprising:
a spoiler mounted on the top surface of the third airfoil;
a spoiler actuator operatively coupled to the spoiler;
a controller operatively coupled to the spoiler actuator;
an electronic signal link to provide instructions from a flight deck to the controller.

2. The controller of claim 1 being programmed with instructions to:
place the third airfoil in a low lift configuration during a first operating mode by directing the spoiler actuator to extend the spoiler;
place said airfoil in a high lift configuration during a second operating mode by directing the spoiler actuator to retract the spoiler.

3. The system of claim 1 wherein the controller is further operatively coupled to an airfoil actuator, said controller being programmed with instructions to:
direct the airfoil actuator to partially extend the third airfoil laterally from the fuselage wherein said airfoil is in the low lift mode;
direct the airfoil actuator to fully extend said airfoil laterally from the fuselage wherein said airfoil is in the high lift mode;
direct the spoiler actuator to extend or retract the spoiler independently of said airfoil position.

4. The system of claim 1 further comprised of:
a flap rotationaly connected to the third airfoil so as to form a portion of the trailing edge of said airfoil;
the controller of claim 1 further operatively coupled to a flap actuator operatively coupled to the flap wherein the controller is programmed with instructions to:
place said airfoil in a high lift configuration by directing the flap actuator to extend the flap downwardly;
when said flap is extended downwardly, place said airfoil in a low lift configuration by directing the spoiler actuator to extend the spoiler.

5. The system of claim 4 wherein the controller is programmed with instructions to:
maintain the third airfoil in the low lift configuration by directing the flap actuator and the spoiler actuator to retract the flap and the spoiler in a coordinated manner.

6. The system of claim 1 further comprised of the third airfoil being tiltably connected to the fuselage by a spar capable of rotating on an axis lateral to the fuselage;
the controller is further operatively coupled to a tilting actuator operatively coupled to said spar wherein the controller is programmed with instructions to:
place said airfoil in a high lift configuration by directing the tilting actuator to rotate the spar wherein said airfoil has a high angle of attack to the relative wind;
place said airfoil in a low lift configuration by directing the tilting actuator to rotate the spar wherein said airfoil has a low angle of attack to the relative wind.

7. An aircraft comprised of:
a fuselage;
a main airfoil means of creating a lifting force;
a second airfoil means of creating a downforce positioned aft of the main airfoil, said second airfoil together with said main airfoil provide a means whereby the longitudinal stability and balance of said aircraft are controlled;
a third airfoil means of creating a variable lifting force positioned forward of the main airfoil;
a control system for controlling the variable lifting force of the third airfoil.

8. The control system of claim 7 comprised of:
an electronic signal link to provide instructions from a flight deck to a controller, said controller operatively coupled to an airfoil actuator, said controller being programmed with instructions to:
direct the airfoil actuator to partially extend the third airfoil laterally from the fuselage wherein said airfoil is in the low lift mode;
direct the airfoil actuator to fully extend said airfoil laterally from the fuselage wherein said airfoil is in the high lift mode.

9. The control system of claim 7 comprised of:
an electronic signal link to provide instructions from a flight deck to a controller, said controller operatively coupled to a flap actuator operatively coupled to a flap rotationally connected to the third airfoil so as to form a portion of the trailing edge of said airfoil wherein the controller is programmed with instructions to:
place said flap in a high lift configuration by directing the flap actuator to extend the flap downwardly;
place said flap in a low lift configuration by directing the flap actuator to retract the flap upwardly.

10. The control system of claim 7 further comprised of the third airfoil being tiltably connected to the fuselage by a spar capable of rotating on an axis lateral to the fuselage;
the controller is further operatively coupled to said tilting actuator operatively coupled to said spar wherein the controller is programmed with instructions to:
place said airfoil in a high lift configuration by directing the tilting actuator to rotate the spar wherein said airfoil has a high angle of attack to the relative wind;
place said airfoil in a low lift configuration by directing the tilting actuator to rotate the spar wherein said airfoil has a low angle of attack to the relative wind.

11. An aircraft comprised of:
a fuselage;
a main airfoil means of creating a lifting force, said lifting force having a center of pressure aft of a center of gravity of said aircraft;
a second airfoil means of creating a downforce positioned aft of the center of pressure, said second airfoil together with said main airfoil provide a means whereby the longitudinal stability and balance of said aircraft are controlled;
a third airfoil means of creating a variable lifting force positioned forward of the main airfoil, said third airfoil being substantially smaller than either the main airfoil or the second airfoil;
a control system for controlling the variable lifting force of the third airfoil whereby the longitudinal location of the center of pressure is controlled.

12. The control system of claim 11 controlling the variable lifting force of the third airfoil comprising:
a spoiler mounted on the top surface of the third airfoil;
a spoiler actuator operatively coupled to the spoiler;
a controller operatively coupled to the spoiler actuator;
an electronic signal link to provide instructions from a flight deck to the controller.

13. The controller of claim 12 being programmed with instructions to:
place the third airfoil in a low lift configuration during a first operating mode by directing the spoiler actuator to extend the spoiler;
place said airfoil in a high lift configuration during a second operating mode by directing the spoiler actuator to retract the spoiler.

14. The control system of claim 11 comprised of:
an electronic signal link to provide instructions from a flight deck to a controller, said controller operatively coupled to an airfoil actuator, said controller being programmed with instructions to:
direct the airfoil actuator to partially extend the third airfoil laterally from the fuselage wherein said airfoil is in the low lift mode;
direct the airfoil actuator to fully extend said airfoil laterally from the fuselage wherein said airfoil is in the high lift mode.

15. The control system of claim 10 comprised of:
an electronic signal link to provide instructions from a flight deck to a controller, said controller operatively coupled to a flap actuator operatively coupled to a flap rotationally connected to the third airfoil so as to form a portion of the trailing edge of said airfoil wherein the controller is programmed with instructions to:
place said flap in a high lift configuration by directing the flap actuator to extend the flap downwardly;
place the flap in a low lift configuration by directing the flap actuator to retract said flap upwardly.

16. The control system of claim 11 further comprised of the third airfoil being tiltably connected to the fuselage by a spar capable of rotating on an axis lateral to the fuselage;
the controller is further operatively coupled to said tilting actuator operatively coupled to said spar wherein the controller is programmed with instructions to:
place said airfoil in a high lift configuration by directing the tilting actuator to rotate the spar wherein said airfoil has a high angle of attack to the relative wind;
place said airfoil in a low lift configuration by directing the tilting actuator to rotate the spar wherein said airfoil has a low angle of attack to the relative wind.
